(19) United States
(12) Patent Application Publication
(10) Pub. No.: US 2026/0186229 A1
(43) Pub. Date: Jul. 2, 2026

(54) STOPPER MEMBER AND CAMERA MODULE COMPRISING THE SAME

(71) Applicant: SAMSUNG ELECTRO-MECHANICS CO., LTD., Suwon-si (KR)

(72) Inventors: Jaenam RYU, Suwon-si (KR); Soohyun KIM, Suwon-si (KR); Sunghoon KIM, Suwon-si (KR); Jihae LEE, Suwon-si (KR)

(73) Assignee: SAMSUNG ELECTRO-MECHANICS CO., LTD., Suwon-si (KR)

(21) Appl. No.: 19/263,897

(22) Filed: Jul. 9, 2025

(30) Foreign Application Priority Data
Dec. 29, 2024 (KR) 10-2024-0191779

(51) Int. Cl. G02B 7/02

(52) U.S. Cl. CPC G02B 7/02

(57) ABSTRACT

A stopper member configured to restrict a movement of a lens barrel, includes a base part, disposed above a case covering external portions of the lens barrel, including an opening extending through a surface of the base part disposed to accommodate the lens barrel.

### CROSS-REFERENCE TO RELATED APPLICATIONS

This application claims the benefit under 35 USC 119(a) of Korean Patent Application No. 10-2024-0191779 filed on Dec. 19, 2024, in the Korean Intellectual Property Office, the entire disclosure of which is incorporated herein by reference for all purposes.

### BACKGROUND

### 1. Field

The present disclosure relates to a stopper member and a camera module comprising the same.

### 2. Description of the Background

With the significant development of information, communication, and semiconductor technologies, the supply and use of electronic devices have rapidly increased. Cameras are currently used in portable electronic devices such as smartphones, tablet PCs, and laptop computers.

In the field of camera modules, high-performance features such as high resolution, slimness, high magnification, and continuous zoom are desired. For example, as development advances towards higher pixel counts, larger image sensors are desired, which may necessitate bigger lenses and actuators to operate them, increasing the overall size and weight of the camera module, potentially making the camera module more susceptible to reliability issues.

Generally, a camera module may be equipped with an Auto Focus (AF) function, an Optical Image Stabilization (OIS) function, and a zoom function, where an actuator drives the lens to move to the desired position. Until power is supplied to the camera module, the lens moves freely within the actuator beyond the range for AF and OIS functions up to the mechanical maximum design limit.

As the size and weight of the lens increase, a greater impact is exerted on the actuator and lens within the camera module upon dropping, causing the actuator components to move and collide, which can result in foreign substances on the surface. If these foreign substances move to the top of the image sensor, spots or scratches may appear in the camera image. Additionally, if foreign substances move inside the actuator, it can also lead to a decline in driving performance. Continuous impact and accumulated stress can cause deformation of the entire structure, leading to appearance defects or performance degradation.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a stopper member configured to restrict a movement of a lens barrel, includes a base part, disposed above a case covering external portions of the lens barrel, including an opening extending through a surface of the base part disposed to accommodate the lens barrel.

The stopper member may further include a stopping part disposed opposite the lens barrel to limit the lens barrel from exceeding an ultra-close focal distance.

The stopping part may be disposed on a lower surface of the base part.

The stopping part may protrude from a lower surface of the base part.

The stopping part may be disposed on an inner wall surface of the opening.

The opening may have a smaller diameter than a hollow portion disposed on an upper surface of the case to accommodate the lens module.

The opening may include an area perpendicular to an optical axis that decreases toward a top surface of the opening.

The stopper member may further include a frame disposed on an upper portion of the base part and having a hollow portion to accommodate a portion of the case exposed outside of the lens barrel.

The stopper member may further include a film disposed to cover the hollow portion of the frame.

The stopper member may further include a reinforcing plate disposed between the case and the base part and having a hollow portion into which the lens barrel is inserted.

A camera module may include a lens module including at least one lens and the lens barrel; a case having a hollow portion disposed to accommodate the lens barrel; and the stopper member above disposed above the case to limit the lens barrel from exceeding an ultra-close focal distance.

In another general aspect, a camera module includes a lens module including at least one lens and a lens barrel that accommodates the at least one lens; a case having a hollow portion disposed to accommodate the lens barrel; and a stopper member disposed above the case to limit the lens barrel from exceeding an ultra-close focal distance.

The stopper member may include a base part, disposed above the case, including an opening extending through a surface of the base part disposed to accommodate the lens barrel.

The stopper member may further include a stopping part disposed opposite the lens barrel to limit the lens barrel from exceeding the ultra-close focal distance.

The stopping part may be disposed on a lower surface of the base part.

The stopping part may be disposed on an inner wall surface of the opening.

The opening may have a smaller diameter than a hollow portion disposed on an upper surface to accommodate the lens barrel.

The opening may include an area perpendicular to an optical axis that decreases toward a top surface of the opening.

The camera module may further include a reinforcing plate disposed between the case and the base part and having a hollow portion into which the lens barrel is inserted.

The stopper member may include a stopper configured to limit a movement of the lens barrel to not exceed the ultra-close focal distance; a frame disposed on an upper portion of the stopper and having a hollow portion to accommodate a portion of the case exposed outside of the lens barrel; a film disposed to cover the hollow portion of the frame; and a reinforcing plate disposed between the case and the base part and having a hollow portion into which the lens barrel is inserted.

Other features and aspects will be apparent from the following detailed description, the drawings, and the claims.

### BRIEF DESCRIPTION OF DRAWINGS

FIG. 1 is a perspective view illustrating the exterior of a camera module according to an embodiment.

FIG. 2 is an exploded perspective view schematically illustrating the camera module according to an embodiment.

FIG. 3 is a cross-sectional view taken along a line I-I′ of FIG. 1.

FIG. 4 is a perspective view showing a stopper member in the camera module shown in FIG. 1.

FIG. 5 is a plan view of the stopper member shown in FIG. 4.

FIG. 6 is a bottom perspective view of the stopper member shown in FIG. 4.

FIG. 7 is a cross-sectional view taken along a line II-II′ of FIG. 4.

FIG. 8 is an exploded perspective view schematically illustrating the stopper member shown in FIG. 4.

FIG. 9 is a perspective view illustrating a part of the stopper member shown in FIG. 4.

FIG. 10 is a perspective view illustrating a part of a stopper member according to another embodiment.

FIG. 11 is an illustration showing the lens movement range of a camera module according to an embodiment and a camera module according to a comparative example.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

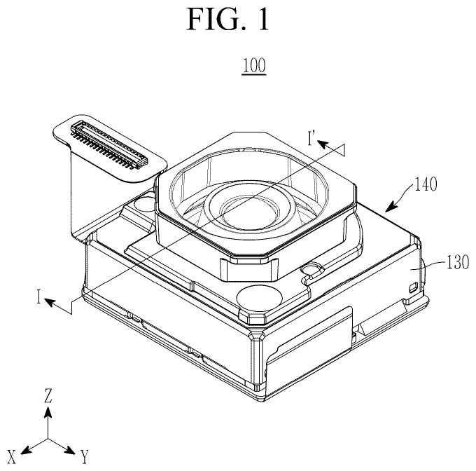

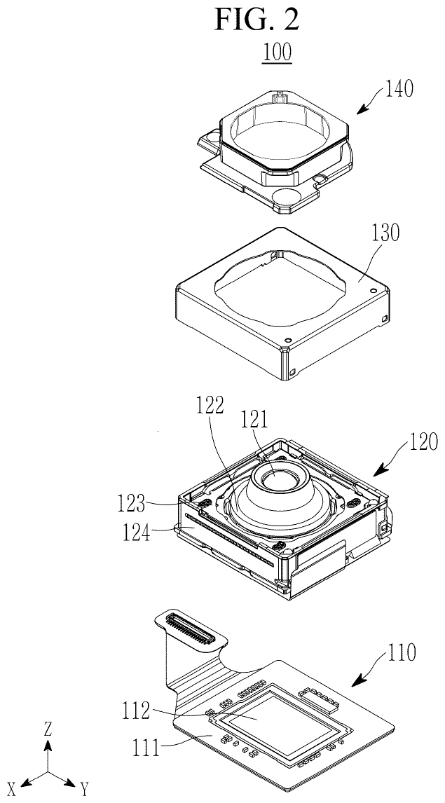

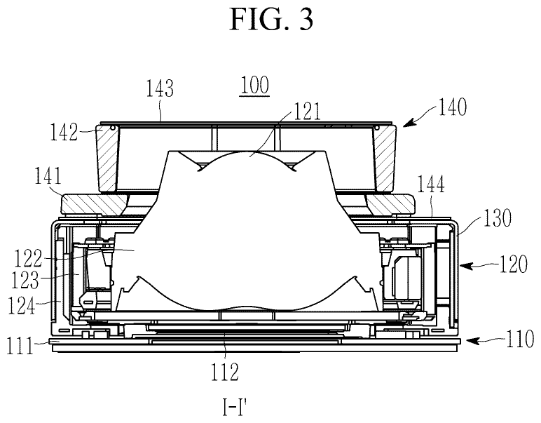

FIG. 1 is a perspective view illustrating the exterior of a camera module according to an embodiment. FIG. 2 is an exploded perspective view schematically illustrating the camera module according to an embodiment, and FIG. 3 is a cross-sectional view taken along a line I-I′ of FIG. 1.

Referring to FIGS. 1 to 3, a camera module 100 according to the present embodiment includes an image sensor module 110, a lens module 120, a case 130, and a stopper member 140.

The image sensor module 110 includes a circuit board 111 and an image sensor 112. The circuit board 111 is electrically connected to a main board (not shown) and may include a circuit board electrically connected to a main board (not shown) and having a wiring pattern that can be electrically connected, such as a rigid circuit board, a flexible circuit board, or a rigid flexible circuit board. The circuit board 111 may have one surface on which an image sensor 112 mounted, and may include a connection pad for connection of the image sensor 112.

The image sensor 112, which is a device that converts light incident through the lens 121 of the lens module 120 into an electrical signal, may be either a charge coupled device (CCD) or a complementary metal oxide semiconductor (CMOS), the present disclosure is not limited thereto. The image sensor 112 may be disposed below the lens module 120 along an optical axis direction of the lens 121 and connected to the connection pad of the circuit board 111 through a bonding wire. The connection between the image sensor 112 and the circuit board 111 is not limited thereto, and it is obvious that various modifications are possible for connection of electronic components mounted on the circuit board 111. The electrical signal converted by the image sensor 112 is outputted as an image through a display unit of an electronic device.

The lens module 120 includes a lens 121, a lens barrel 122 accommodating the lens 121, a lens driving device 123 that moves the lens barrel 122, and a housing 124 accommodating the lens driving device 123 and the lens barrel 122.

The lens 121 may include one or more lenses having the same or different optical characteristics such as a refractive index, and is mounted on the lens barrel 122 along an optical axis. Herein, the optical axis may be set to a central axis of the lens accommodated in the lens barrel 122, and the optical axis direction refers to a direction parallel to this central axis. The lens 121 may be disposed as desired depending on a design of the lens barrel 122.

The lens barrel 122 may have a hollow cylindrical shape such that one or more lenses 121 for imaging a subject can be accommodated therein, an image sensor 112 may be disposed below the lens barrel 122 along the optical axis direction to convert light incident through the lens barrel 122 into an electrical signal, and the converted electrical signal may be transmitted to the circuit board 111 and transmitted to an electronic device such as a mobile phone. The lens barrel 122 may move in a direction of the optical axis or in a direction perpendicular to the optical axis while accommodated in the housing 124 by a driving force of the lens driving device 123.

Although not shown, an optical filter may be disposed between the lens barrel 122 and the image sensor 112. The optical filter may block light of a specific frequency bandwidth from light passing through the lens from entering the image sensor. For example, the optical filter may include an IR cut off filter.

The lens driving device 123 is a device that moves the lens barrel 122 and includes an auto focus (AF) driver (not shown) and an optical image stabilization (OIS) driver (not shown). For example, the AF driver may include an AF driving magnet and an AF driving coil, and electromagnetic influence therebetween moves the lens barrel 122 along the optical axis to implement a focus adjustment function or a zoom function. In addition, the OIS driver may include an OIS driving magnet and an OIS driving coil, and may implement a function of correcting hand shake or shaking by moving the lens barrel 122 in a direction perpendicular to the optical axis by the electromagnetic influence therebetween.

The housing 124 may accommodate the lens barrel 122 and the lens driving device 123 in an internal space, and for example, the housing 124 may have a box shape with upper and lower portions which are open. The circuit board 111 is disposed underneath the housing 124.

The case 130 may be coupled to the housing 124 to cover the lens barrel 122 and the housing 124. The case 130 has a hollow portion on the top surface where the lens barrel 122 is inserted, and it may have a frame shape with an open lower portion and four corners. The case 130 protects internal components of the camera module 100. The case 130 may be made of a metal plate or a material with a low corrosion rate, such as stainless steel.

The case 130 may function to block an electromagnetic wave. For example, the case 130 may shield electromagnetic waves to prevent electromagnetic waves generated inside the camera module 100 from affecting other electronic components within the electronic device or noise currents flowing from outside the camera module 100 from affecting the inside of the camera module 100. The case 130 may be grounded to the circuit board 111 to shield electromagnetic waves inside and outside the camera module 100.

The stopper member 140 may be disposed at the upper part of the case 130. The stopper member 140 serves to prevent foreign substances from entering the inside of the camera module 100 and to restrict the movement of the lens barrel 122.

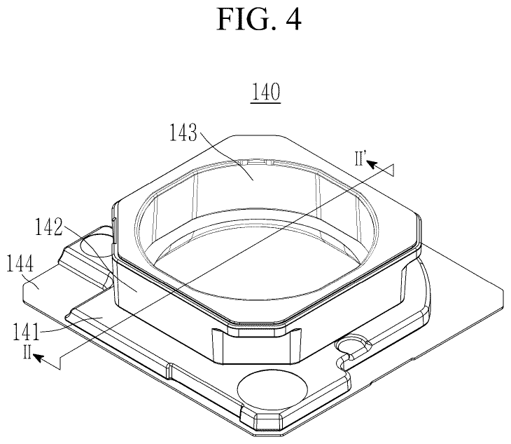

Hereinafter, the stopper member 140 of the camera module 100 according to the present embodiment will be described in more detail with reference to FIGS. 4 to 9.

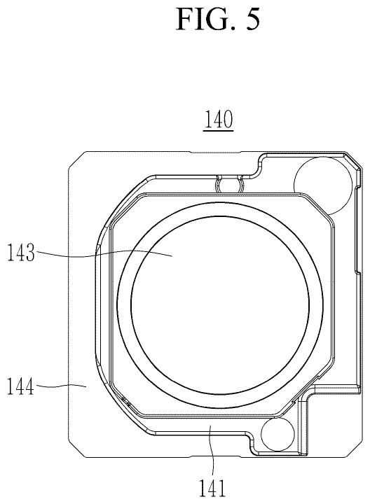

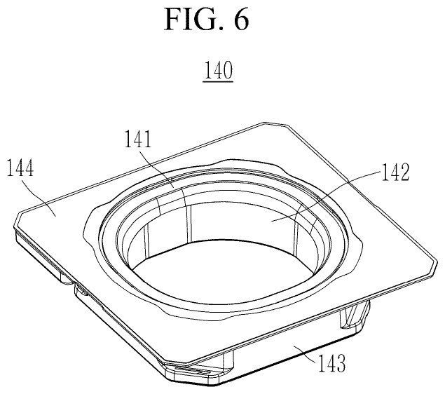

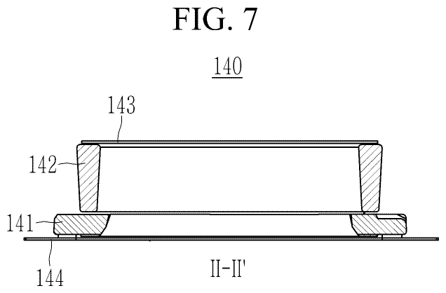

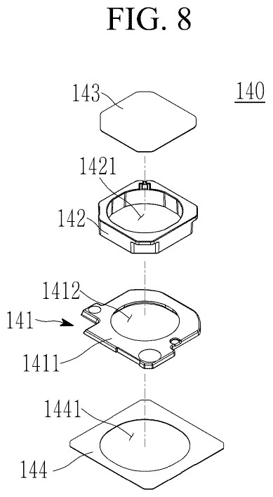

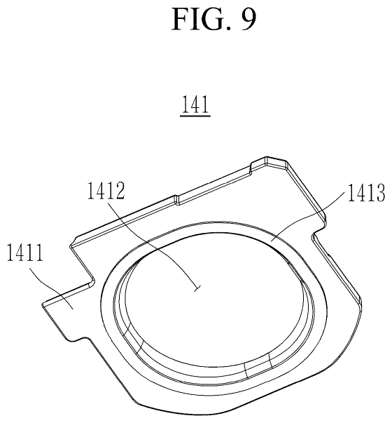

FIG. 4 is a perspective view showing a stopper member in the camera module shown in FIG. 1. FIG. 5 is a plan view of the stopper member shown in FIG. 4. FIG. 6 is a bottom perspective view of the stopper member shown in FIG. 4. FIG. 7 is a cross-sectional view taken along a line II-II′ of FIG. 4. FIG. 8 is an exploded perspective view schematically illustrating the stopper member shown in FIG. 4. FIG. 9 is a perspective view illustrating a part of the stopper member shown in FIG. 4.

Referring to FIGS. 4 to 9, the stopper member 140 of the camera module 100 according to the present embodiment includes a stopper 141, a frame 142 disposed above the stopper 141, a film 143 covering the hollow portion of the frame 142, and a reinforcement plate 144 disposed below the stopper 141.

The stopper 141 may include a base part 1411 disposed above the case 130 and a stopping part 1413 disposed to face the lens barrel 122.

The base part 1411 has an opening 1412 formed at the center to allow the insertion of the lens barrel 122, and its shape may be modified to fit the decorative part of the electronic device to which the camera module 100 is assembled. Therefore, when combined with the electronic device, the assembly becomes more efficient and precise, which can improve decentering.

The opening 1412 may be formed to penetrate the base part 1411 in the optical axis direction. The opening 1412 may have a smaller diameter than the hollow portion of the case 130 to prevent foreign substances from entering the inside of the camera module 100 and to limit the movement of the lens barrel 122. Additionally, the opening 1412 can be formed so that the area in the direction perpendicular to the optical axis decreases toward the top. This can prevent the lens barrel 122 from passing through and moving within the opening 1412.

The stopping part 1413 may be formed on the lower surface of the base part 1411 and may be formed in proximity to the opening 1412. The stopping part 1413 may form the same plane as the lower surface of the base part 1411 or may be formed by protruding in the optical axis direction from the lower surface of the base part 1411.

If the stopping part 1413 forms the same plane as the bottom surface of the base part 1411, a portion of the bottom surface of the base part 1411 can serve the function of the engaging part. In other words, when the lens module 120 moves due to external impacts or the like, the top surface of the lens barrel 122 comes into contact with the bottom surface of the base part 1411. Therefore, the base part 1411 can limit the movement of the lens barrel 122 to prevent it from exceeding the ultra-close focal distance.

If the stopping part 1413 protrudes from the lower surface of the base part 1411, the stopping part 1413 may be disposed in the hollow portion of the case 130. When the lens module 120 moves due to external impact or other reasons, the upper surface of the lens barrel 122 comes into contact with the stopping part 1413, thus restricting the movement of the lens barrel 122 to prevent it from exceeding the ultra-close focal distance.

The frame 142 may be disposed above the base part 1411 and may have a hollow portion 1421 into which the lens module 120 is inserted. The frame 142 accommodates the part exposed outside the case 130 of the lens barrel 122 and has a height greater than the exposed part to protect it. The frame 142 may have a structure of a frame with open top and bottom. The hollow portion 1421 is formed to penetrate the frame 142 in the optical axis direction and may have a diameter equal to or greater than the diameter of the opening 1412.

The film 143 covers the hollow portion 1421 of the frame 142 to protect the lens 121 and prevent foreign substances from entering the inside of the camera module 100. The film 143 may be a transparent or translucent optical film. When assembling the camera module 100 into an electronic device or when the lens module 120 moves due to external impact, a gap may be formed between the film 143 and the upper surface of the lens 121 to prevent collision with the upper surface of the lens 121. The frame 142 and the film 143 may be separated from the camera module 100 after assembling the camera module 100 into the electronic device.

The reinforcement plate 144 may be disposed between the case 130 and the base part 1411 and may have a hollow portion 1441 into which the lens barrel 122 is inserted. The reinforcement plate 144 serves to enhance the mechanical strength of the stopper 141 and can be made from polymer materials such as polyimide (PI), FR-4, or polyester (PE), or from metal materials such as stainless steel (SUS) or aluminum.

According to the present embodiment, by separately attaching a stopper member 140 to the upper surface of the case 130, the movement of the lens barrel 122 can be restricted to an ultra-close focal distance, preventing the lens 121 from colliding when assembling the camera module 100 into an electronic device. At the same time, the assembly process is improved, allowing for better decentering correction. Additionally, in the event of a drop of the camera module 100, it is possible to prevent reliability issues caused by collisions on the upper surface of the lens 121 in advance.

In the present embodiment, the stopper member 140 is designed such that when assembling the camera module 100 into an electronic device, only the frame 142 and film 143 are separated from the camera module 100, while the stopper 141 remains. Therefore, it can continue to function as a stopper that limits the movement of the lens barrel 122 within the ultra-close focal distance.

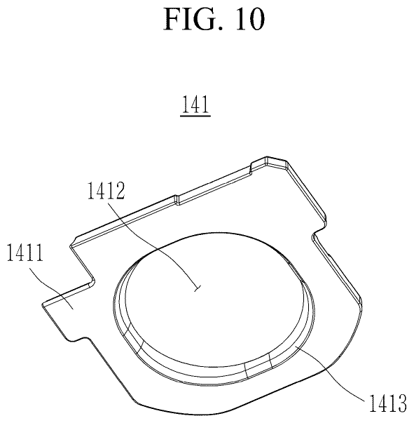

Hereinafter, a stopper member according to another embodiment will be described in more detail with reference to FIG. 10. FIG. 10 is a perspective view illustrating a part of a stopper member according to another embodiment.

Referring to FIG. 10, the stopper member according to this embodiment has differences from the stopper of the embodiment described with reference to FIGS. 4 to 9. Below, different configurations are described, and the same drawing symbols are used for the same configurations, and configurations not described separately may be configured in the same manner as the embodiments illustrated in FIGS. 4 to 9.

The stopper 141 may include a base part 1411 disposed above the case 130 and a stopping part 1413 arranged to face the lens barrel 122.

The base part 1411 is formed with an opening 1412 in the center to allow the insertion of the lens barrel 122, and the inner wall on the side of the opening 1412 may be inclined toward the center as it goes upward. At this time, the base part 1411 may have only a part of the inner wall on the side of the opening 1412 inclined, for example, only the lower part.

The opening 1412 may be formed such that the area in the direction perpendicular to the optical axis decreases toward the top. At this time, the lower part of the opening 1412 may be formed so that the area in the direction perpendicular to the optical axis decreases toward the top, and the upper part may have a constant area in the direction perpendicular to the optical axis.

The stopping part 1413 may be formed on the inner wall on the side of the opening 1412 of the base part 1411. To prevent the lens barrel 122 from moving through the opening 1412, the stopping part 1413 may be formed on the lower part of the inner wall on the side of the opening 1412 of the base part 1411. That is, the stopping part 1413 may be formed on the inclined part of the inner wall on the side of the opening 1412 of the base part 1411, e.g., on the inclined part of the lower inner wall on the side of the opening 1412 of the base part 1411. Since the stopping part 1413 is disposed opposite the upper surface of the lens barrel 122, it can prevent the lens barrel 122 from moving beyond the ultra-close focal distance due to external impact or the like. Therefore, it is possible to limit the movement of the lens barrel 122 so that it moves between the infinity focal distance and the ultra-close focal distance.

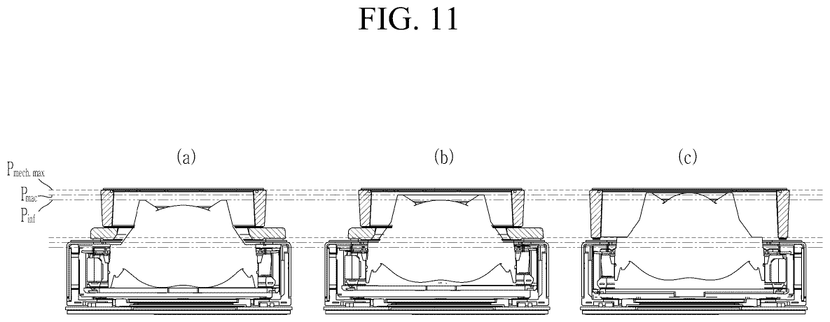

Hereinafter, the lens movement range of a camera module according to an embodiment and a camera module according to a comparative example will be described in more detail with reference to FIG. 11. FIG. 11 is an illustration showing the lens movement range of a camera module according to an embodiment and a camera module according to a comparative example.

Referring to FIG. 11, as shown in (a), the lens barrel is disposed at the infinity focal distance position (P_{inf}). When power is applied to the camera module and the AF function is activated, the lens barrel can move between the infinity focal distance position (P_{inf}) and the ultra-close focal distance position (P_{mac}).

According to the embodiment shown in FIG. 11(b), the movement of the lens barrel in the camera module is limited within the ultra-close focal distance position (P_{mac}) by the stopper member. That is, according to this embodiment, when the lens barrel is about to move beyond the ultra-close focal distance position (P_{mac}) to the mechanical limit position (P_{mech. Max}) due to external impact or the like, the upper surface of the lens barrel can be prevented from doing so by being caught by the stopper member.

On the other hand, in the camera module according to the comparative example shown in FIG. 11(c), there is no configuration to limit the movement of the lens barrel. Therefore, if an external impact is applied, the lens barrel can move beyond the ultra-close focal distance position (P_{mac}) to the mechanical limit position (P_{mech. max}). As a result, the upper surface of the lens may collide with the film, which can lead to a deterioration in the performance of the camera module. Additionally, since the cover is removed after the camera module is assembled into the electronic device, foreign substances may enter the inside of the camera module.

On the other hand, in the case of the camera module according to one embodiment, the movement of the lens barrel is limited within the ultra-close focal distance position (P_{mac}) by the stopper member, thus preventing collision on the upper surface of the lens. Furthermore, since the stopper member remains even after the camera module is assembled into the electronic device, it can still limit the movement range of the lens barrel while blocking the ingress of foreign substances into the camera module.

One or more embodiments attempt to provide a stopper member that can prevent foreign substances from entering the inside of the camera module, mitigate the impact when the camera module is dropped, and simultaneously limit the movement range of the lens, as well as a camera module including the stopper member.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A stopper member that restricts a movement of a lens barrel, comprising:
a base part, disposed above a case covering external portions of the lens barrel, comprising an opening extending through a surface of the base part disposed to accommodate the lens barrel.

2. The stopper member of claim 1, further comprising
a stopping part disposed opposite the lens barrel to limit the lens barrel from exceeding an ultra-close focal distance.

3. The stopper member of claim 2, wherein
the stopping part is disposed on a lower surface of the base part.

4. The stopper member of claim 2, wherein
the stopping part protrudes from a lower surface of the base part.

5. The stopper member of claim 2, wherein
the stopping part is disposed on an inner wall surface of the opening.

6. The stopper member of claim 1, wherein
the opening has a smaller diameter than a hollow portion disposed on an upper surface of the case to accommodate the lens module.

7. The stopper member of claim 1, wherein
the opening comprises an area perpendicular to an optical axis that decreases toward a top surface of the opening.

8. The stopper member of claim 1, further comprising
a frame disposed on an upper portion of the base part and having a hollow portion to accommodate a portion of the case exposed outside of the lens barrel.

9. The stopper member of claim 8, further comprising
a film disposed to cover the hollow portion of the frame.

10. The stopper member of claim 1, further comprising
a reinforcing plate disposed between the case and the base part and having a hollow portion into which the lens barrel is inserted.

11. A camera module, comprising:
a lens module comprising at least one lens and the lens barrel;
a case having a hollow portion disposed to accommodate the lens barrel; and
the stopper member of claim 1 disposed above the case to limit the lens barrel from exceeding an ultra-close focal distance.

12. A camera module, comprising:
a lens module comprising at least one lens and a lens barrel that accommodates the at least one lens;
a case having a hollow portion disposed to accommodate the lens barrel; and
a stopper member disposed above the case to limit the lens barrel from exceeding an ultra-close focal distance.

13. The camera module of claim 12, wherein
the stopper member comprises a base part, disposed above the case, comprising an opening extending through a surface of the base part disposed to accommodate the lens barrel.

14. The camera module of claim 13, wherein
the stopper member further comprises a stopping part disposed opposite the lens barrel to limit the lens barrel from exceeding the ultra-close focal distance.

15. The camera module of claim 14, wherein
the stopping part is disposed on a lower surface of the base part.

16. The camera module of claim 14, wherein
the stopping part is disposed on an inner wall surface of the opening.

17. The camera module of claim 13, wherein
the opening has a smaller diameter than a hollow portion disposed on an upper surface to accommodate the lens barrel.

18. The camera module of claim 13, wherein
the opening comprises an area perpendicular to an optical axis that decreases toward a top surface of the opening.

19. The camera module of claim 12, further comprising
a reinforcing plate disposed between the case and the base part and having a hollow portion into which the lens barrel is inserted.

20. The camera module of claim 12, wherein
the stopper member comprises:
a stopper configured to limit a movement of the lens barrel to not exceed the ultra-close focal distance;
a frame disposed on an upper portion of the stopper and having a hollow portion to accommodate a portion of the case exposed outside of the lens barrel;
a film disposed to cover the hollow portion of the frame; and
a reinforcing plate disposed between the case and the base part and having a hollow portion into which the lens barrel is inserted.
